(19) United States
(12) Patent Application Publication
(10) Pub. No.: US 2005/0125437 A1
(43) Pub. Date: Jun. 9, 2005

(54) Data analysis system and method

(76) Inventor: Andrew John Cardno, Henderson, NV (US)

Correspondence Address: COMPUDIGM SERVICES INC., 1550 W. Horizon Ridge Parkway, SUITE A, Henderson, NV, 89012, US

(21) Appl. No.: 10/728,857

(22) Filed: Dec. 8, 2003

(51) Int. Cl. G06F 17/00

(52) U.S. Cl. 707/102; 707/104.1

(57) ABSTRACT

A data visualisation system for a method of data analysis comprising a database of interaction data between customers and merchants; a display of a graphical spatial representation of at least part of the commercial premises of a merchant; retrieving from the interaction database a plurality of data values representing interactions between customers and merchants; generating and superimposing a representation of the data values on the spatial representation; and superimposing a representation of interactions between customers and merchants associated with part of the spatial representation selected by a user in order to answer business value questions.

### FIELD OF INVENTION

The invention relates to a data analysis system and method, particularly but not solely designed for analyzing revenue from individual gaming machines in a casino. The invention also has an application in any merchant and customer interaction, for example retail sales of goods or services.

### BACKGROUND TO INVENTION

The low cost of data storage hardware has led to the collection of large volumes of data. Merchants, for example, generate and collect large volumes of data during the course of their business. To compete effectively, it is necessary for a merchant to be able to identify and use information hidden in the collected data. This data could include revenue from gaming machines in a casino, or revenue from sales of any goods or services from a merchant to a customer. The task of identifying this hidden information has proved very difficult for merchants.

PCT patent specification WO 00/77682 describes a system for displaying a contoured representation of data. Such contouring provides a user with a broad overview of a set of data. It would be particularly desirable to provide a user with such a contoured representation to provide a user with an overall impression of data. It would be more desirable to provide such an overview of the data but also providing a user with more specific data on request relating to part of the contoured representation.

### SUMMARY OF INVENTION

In broad terms in one form the invention comprises a data analysis system comprising an interaction database maintained in computer memory, the interaction database comprising interaction data representing interactions between customers and merchants; a spatial display component configured to display a graphical spatial representation of at least part of the commercial premises of a merchant; a retrieval component configured to retrieve from the interaction database a plurality of data values representing interactions between customers and merchants; a contour generator configured to generate and superimpose a representation of the data values on the spatial representation; a user selection component configured to enable a user to select part of the spatial representation; and a data display component configured to superimpose a representation of interactions between customers and merchants associated with the part of the spatial representation selected by the user.

In broad terms in another form the invention comprises a method of data analysis comprising the steps of maintaining in computer memory an interaction database, the interaction database comprising interaction data representing interactions between customers and merchants; displaying a graphical spatial representation of at least part of the commercial premises of a merchant; retrieving from the interaction database a plurality of data values representing interactions between customers and merchants; generating and superimposing a representation of the data values on the spatial representation; and superimposing a representation of interactions between customers and merchants associated with part of the spatial representation selected by a user.

### BRIEF DESCRIPTION OF THE FIGURES

Preferred forms of the data analysis system and method will now be described with reference to the accompanying figures in which:

FIG. 1 shows a block diagram of a system in which one form of the invention may be implemented;

FIG. 2 is a data visualisation generated in accordance with one form of the invention;

FIG. 3 is one specific data display generated in accordance with one form of the invention;

FIG. 4 illustrates the user selection of part of the display of FIG. 2;

FIG. 5 illustrates a preferred form data display generated in accordance with the invention;

FIG. 6 illustrates a data screen presented to a user in accordance with one form of the invention;

FIG. 7 shows the preferred system architecture of hardware on which the present invention may be implemented; and

FIGS. 8A and 8B illustrates a preferred form data set stored in computer memory in accordance with the invention.

### DETAILED DESCRIPTION OF PREFERRED FORMS

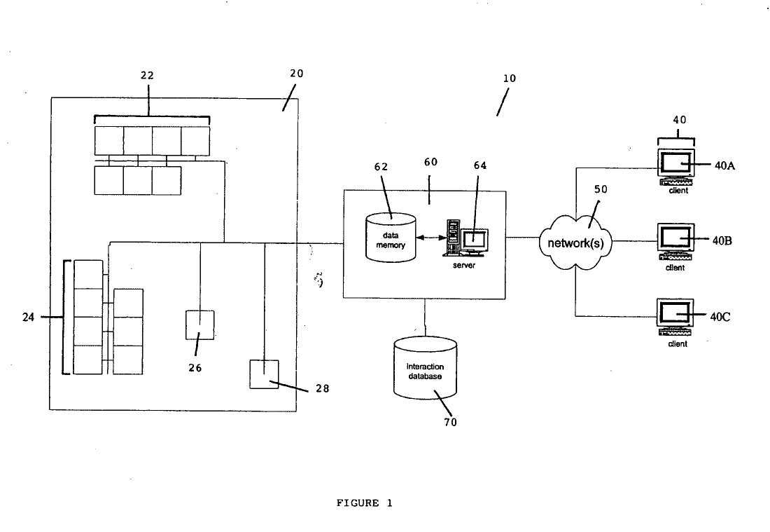

FIG. 1 illustrates a block diagram of the preferred system 10 in which one form of the present invention may be implemented. Typically, a merchant will operate in a commercial premises or store from which a customer purchases one or more merchant products. The merchant may, for example, operate a petrol station in one or more geographic locations. The merchant may alternatively operate a wagering or betting service, or operate a casino or other gaming facility in which several gaming machines and stations are positioned in one or more rooms at a common venue.

A merchant product includes goods sold in a commercial premises, services provided from a commercial premises and facilities and products provided for a user at a commercial premises, for example casino stations and machines. In a casino setting, a merchant product could include a particular gaming machine identified by a machine identifier. The machine could have a range of attributes, for example denomination, game type, game name, cabinet type, manufacturer and so on.

In FIG. 1, merchant 20 operates a casino having several gaming machines available for interactions with customers in the merchant premises. Gaming machines could be grouped together into machine banks, for example bank 22 and bank 24. The merchant may also operate individual gaming machines, for example machines 26 and .28. Each of the machines in machine banks 22 and 24 and machines 26 and 28 are preferably connected to other components of the system 10 with a suitable device such as data bus 30, enabling data to be transferred between the machines and other parts of the system 10.

Each machine may be provided with one or more electronic meters, for example a timer, whether the machine is in use, money placed in the machine or revenue, credit wins (how much money the machine pays back) and how much money is to be paid back by a teller. The data could be transferred in real time to other components of the system 10 or alternatively the meters could be updated locally at the machine and each machine polled periodically by other components of the system.

The system 10 preferably includes one or more clients 40, for example 40A, 40B and 40C which each may comprise a personal computer or workstation described below. Each client could be interfaced to other parts of the network as shown in FIG. 1, through a local area network or LAN, through the Internet, a dial up connection or wireless connection, or any combination of the foregoing.

The system 10 may also include a personal computer or workstation operating under the control of appropriate operating and application software having a data memory 62 connected to a server 64. The system also includes an interaction database 70 which could be maintained in computer memory of workstation 60 or in some other computing device connected to the system 10. Interaction data is stored in the interaction database representing interactions between customers and merchants compiled from the merchant premises 20. The invention is configured to retrieve, compile or otherwise receive data from the merchant premises 20, process the data with the server 60 and optionally store the data in the interaction database 70, and to display the data, or transmit data ready for display, on a client workstation 40, as will be described below.

As a customer interacts with a merchant at the merchant premises 20, the interaction generates interaction data which is then migrated to the interaction database 70. Migration could be performed by way of daily updates or in real time or near real time. It is advantageous to cleanse, catalogue and validate the interaction data during migration of the data to the memory and this could be performed by either the merchant or a third party. The interaction data could be stored as a series of records in a relational database or as a flat file as will be described below.

Where the merchant operates a casino or gaming facility, it is anticipated that at least one record of the interaction data includes an individual gaming machine identifier at which the interaction between the customer and the merchant took place. The merchant may also assign a group identifier to a pre-specified group of machines and may also assign a machine bank identifier to a bank of gaming machines. The interaction data could include a machine identifier, a machine group identifier, and/or a machine bank identifier.

The record could also include data such as the date and/or time at which the interaction between the customer and the merchant took place. Where it is envisaged that the interactions could be prolonged, for example where a customer maintains an interaction with a gaming machine, the date/time identifier could include the date/time when the interaction commenced and the date/time when the interaction was terminated.

At least one of the interaction records could include the value of the interaction, for example the money transferred from the customer to the gaming machine, and where the machine is configured to make payouts to the customer, the net value of the interaction.

The interaction data could also include the spatial position of each gaming machine, for example a floor identifier where the merchant operates from more than one floor, and a location of the machine on that floor.

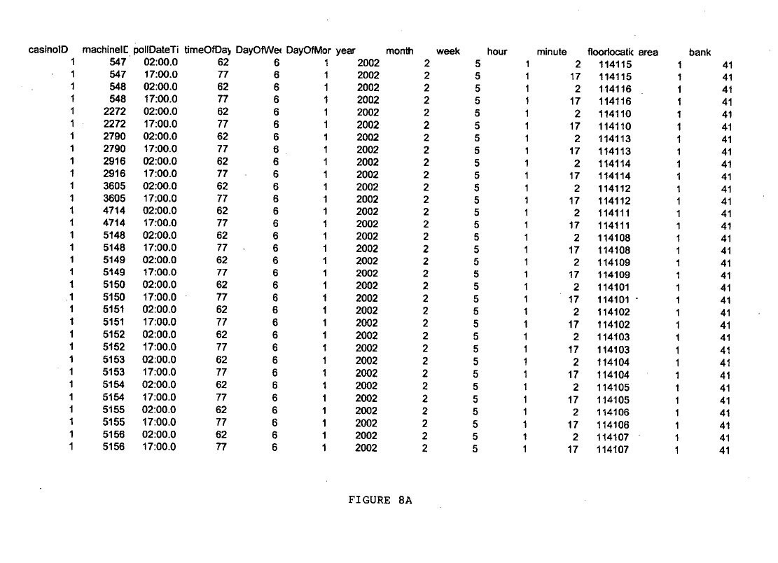

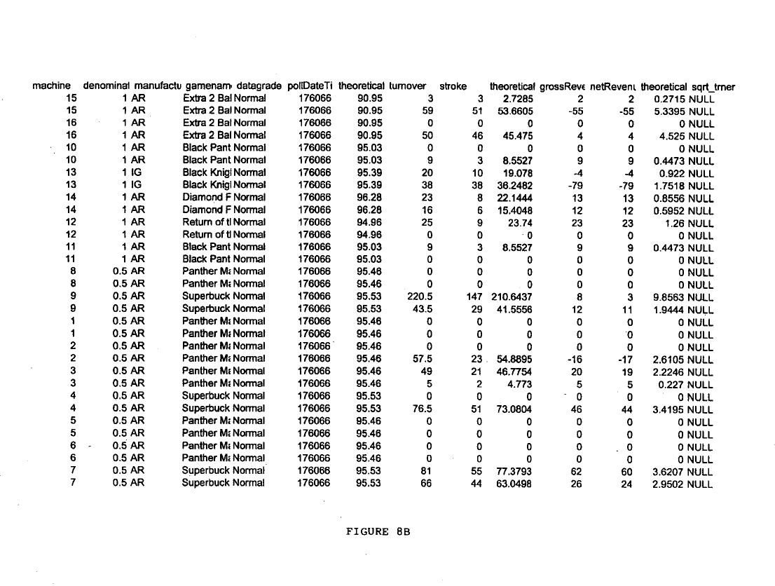

Typical data stored in the interaction database is further described below with reference to FIG. 8.

Where a merchant sells retail products in the form of goods to a customer in a retail environment, the interaction data could include an identifier of the goods and could also include an indicator of the spatial position within the merchant premises at which the goods are displayed to a user.

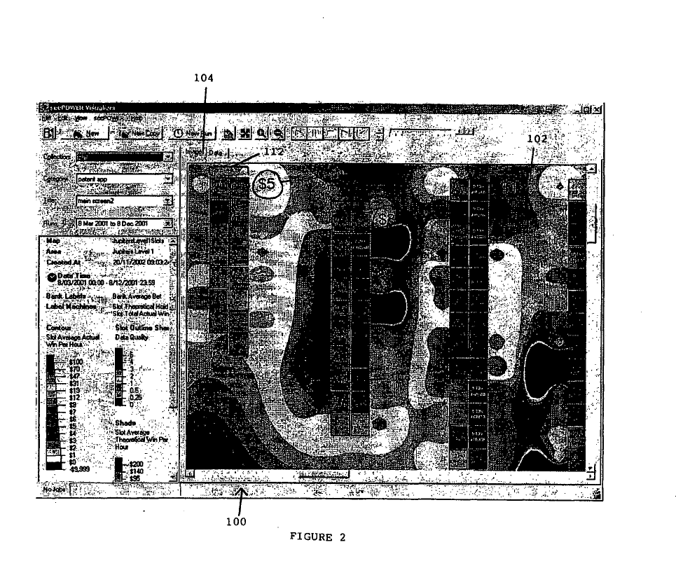

FIG. 2 illustrates at 100 one example of a display generated by the invention where the merchant operates a casino or similar gaming venue. In this example, a representation of the commercial premises of the merchant is generated and displayed, for example in image panel 102. It will be appreciated that the user could be provided with the choice of selecting the image display with an image selection tab 104.

In the display shown in FIG. 2, the graphical spatial representation of at least part of the commercial premises of the merchant includes the layout of individual gaming machines, for example machines 106 and 108 and the layout of individual machine banks, for example 110 and 112. The system includes a spatial display component which is configured to display the graphical spatial representation of at least part of the commercial premises of the merchant. The spatial display component in one form could comprise a computer program operable to either generate a spatial representation of a merchant, or to retrieve such a spatial representation from computer memory and to display the spatial representation.

Where the merchant provides a plurality of products to customers, for example more than one gaming machine in a merchant premises, the spatial representation could show each of the products, for example gaming machines, in locations within the spatial representation corresponding to the spatial position of the products within the commercial premises of the merchant.

One or more of the gaming machines or machine banks could be labeled with one or more labels. For example, labels for machine banks could include the average amount of currency bet on each machine bank as indicated at 114 and 116 respectively for machine banks 110 and 112. The individual machines could each have one or more labels, for example slot theoretical hold and slot total actual win as is shown in FIG. 2. It will be appreciated that any particular label could be selected for individual gaming machines, groups of machines or machine banks.

It is also envisaged that the invention retrieve data from the interaction database in the form of a plurality of data values representing interactions between customers and merchants. These data values in one form could represent revenue values obtained from interactions with individual gaming machines or machine banks. The data values shown in FIG. 2, for example, include the average actual win per hour for individual slots or machines.

In one form the invention could include a retrieval component. The retrieval component could be a software-implemented query configured to retrieve a set of records from the interaction database 70 and to calculate data values from these retrieved records. For example, a set of records involving a particular machine could be retrieved and the total revenue summed for display in the contoured representation. Further data records could be obtained based on selections by the user and the results displayed on the user representation.

A contour generator, such as that described in PCT specification WO 00/77682, is configured to superimpose a representation of these data values onto the spatial representation. In one form, the contour generator could display the values of each of the data values centered on respective data points at different locations throughout the representation. These data points could be positioned in close proximity and preferably adjacent to the representation of corresponding gaming machines in the display. The contour generator generates and displays a contoured representation of at least one of these data values centered on respective data points, such that one or more of the data points is displayed as a local maximum. In another form the contour generator generates and displays data points corresponding to the data values and one or more contour lines around one or more of the data points, each contour line representing data values which are less than the data value of the data point around which the contour line is displayed.

As shown in FIG. 2, the data values are shown in a colour representative of their value and preferably a legend is displayed to a user to indicate the colour or shade corresponding to a particular data value or range of data values.

The representation of FIG. 2 provides a user with a good overview of at least part of a merchant premises and a representation of the interaction between customers and merchants in that commercial premises or part of commercial premises.

The invention further provides a user selection component configured to enable a user to select part of the spatial representation for further review. One example of a user selection component could be a mouse, track ball or joystick controlling a cursor or other position indicator visible to a user.

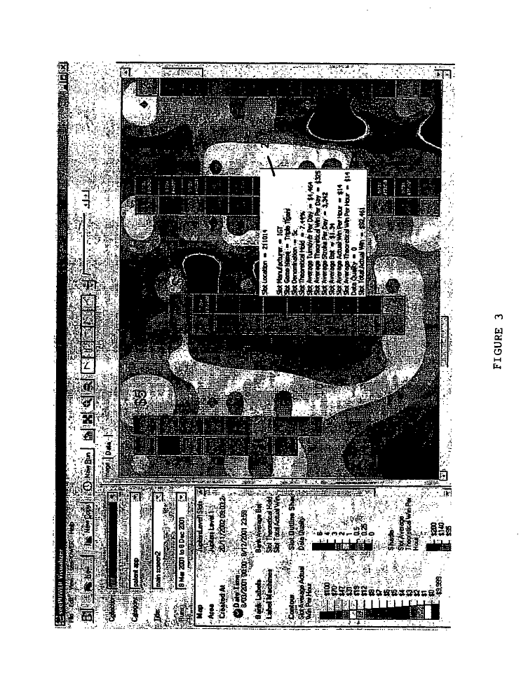

FIG. 3 illustrates a typical cursor which could be displayed to a user. In FIG. 3 the user has positioned cursor 200 over gaming machine or slot 106 and in doing so has selected part of the spatial representation and has selected a product in the spatial representation for further study by the user.

A data display component is configured to superimpose further information 210 over the representation and in particular information associated with the product selected by the user. In one form the component could include a computer program operable to superimpose data representing interactions between customers and merchants associated with the part of the spatial representation or product, for example gaming machine 106, selected by the user.

Preferably the user manipulates the positioning device to position the cursor 200 at a desired location within the spatial representation. If the cursor 200 is positioned over an individual gaming machine for a predetermined period, for example one or two seconds, pop up window 210 is displayed by the data display component.

In FIG. 3, the user has selected gaming machine 106 and the data display component displays to the user further information representing interactions between customers and merchants associated with or involving gaming machine 106.

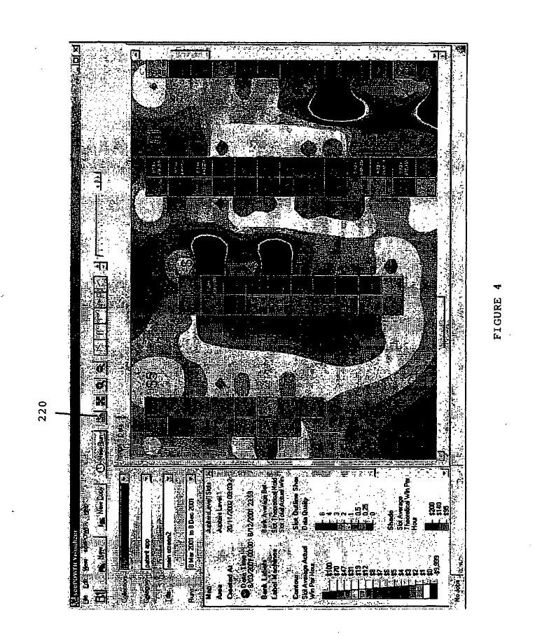

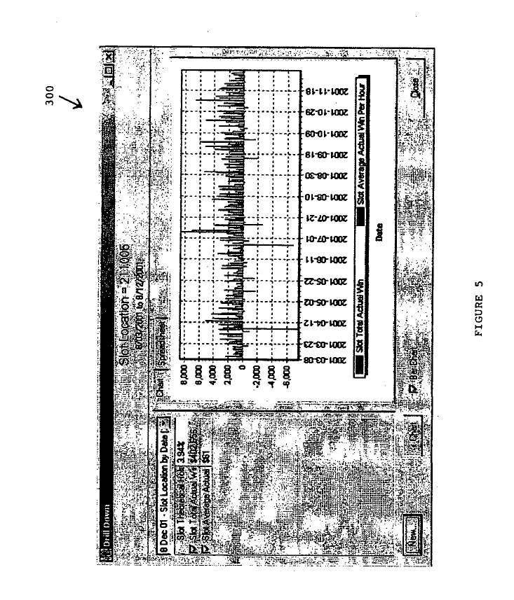

FIGS. 4 and 5 illustrate a further preferred form data display component of the invention where the merchant provides a plurality of products, for example a plurality of gaming machines to customers. As shown in FIG. 4, the user could position cursor 200 over gaming machine 106. The previous function described above with reference to FIG. 3 could display information about that particular gaming machine. It is possible that the user may wish to know further information regarding historic transactions involving that gaming machine, or a summary of transactions involving that gaming machine and other gaming machines.

The user first positions the cursor 200 over gaming machine 106 and then performs some other operation, for example a left click using a mouse. The display 210 from FIG. 3 is removed from the display in recognition of the user's different requirements. On selecting gaming machine 106 by left mouse click, the user then performs a further function, for example clicking a drilldown icon 220. The data display component then displays further interactions as shown in FIG. 5 at 300. The representation 200 could show interactions associated with the gaming machine 106 over a pre-specified or default time interval. Alternatively, the representation 300 could show data representing merchant customer interactions involving more than one product, for example more than one gaming machine.

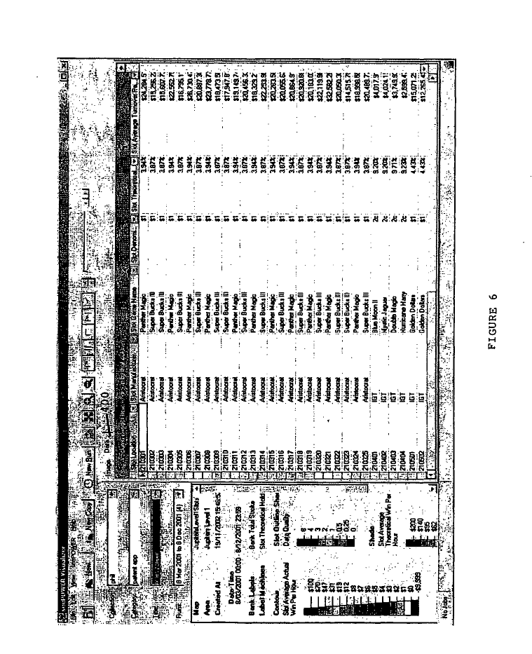

As shown in FIG. 6, the user could elect to display the data from which the representation of FIG. 2 is generated, rather than the representation itself by selecting data tab 400.

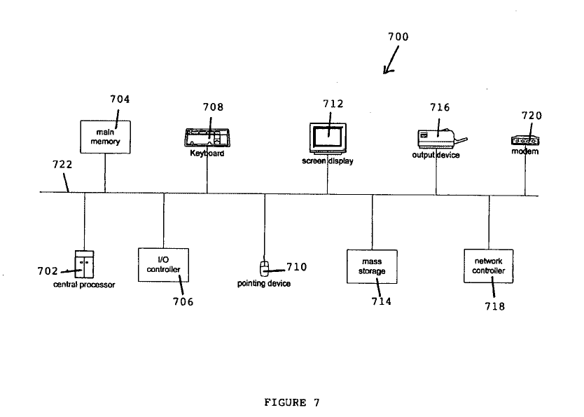

FIG. 7 shows a preferred system architecture of workstation 60 and/or client 40. The computer system 700 typically comprises a central processor 702, a main memory 704 for example RAM and an input/output controller 706. The computer system 700 also comprises peripherals such as a data entry device or keyboard 708, a pointing device 710 for example a mouse, track ball or touch pad, a display or screen device 712, a mass storage memory 714 for example a hard disk, floppy disk or optical disc, and an output device 716 for example a printer. The system 700 could also include a network interface card or controller 718 and/or a modem 720. The individual components of the system 700 could communicate through a system bus 722.

Referring to FIGS. 8A and 8B, it will be appreciated that the nature and format of interaction data stored in the interaction database 70 will depend on the particular application to which the invention is put. FIGS. 8A and 8B illustrate typical interactions which could be stored in the interaction database 70. These interactions could be stored as a series of records in a relational database or as a flat file. It will be appreciated that a relational database could be normalized to reduce data redundancy.

The data could include, for example, a machine identifier, date/time indicators, floor location, area, bank, machine and denomination indicators, manufacturer and game name indicators. Data representing interactions could include turnover, stroke, gross revenue and net revenue and could also theoretical values for these.

The invention enables a user to formulate a business question and then create a visualisation based on data that will answer that question. Various parts of the visualisation are scrutinised for areas of interest. For example, in the casino industry, the user would scan a section and look at the broad level contour representations around each machine bank and then scan the banks and look at the contour areas associated with individual slot machines forming the banks. Scanning provides the user with an overall impression of section and bank performance. For example, the banks near an entrance could be out-performing the areas away from the doors in terms of “handle pull” or bank 2 could have lower “turnover” than bank 6.

Each slot is then scrutinised using one of the methods described above to obtain more specific information. This secondary level of scrutinisation enables the user to develop theories as to why one bank or one area or one type of machine is out-performing another based on one or more attributes. For example, the 25c Ant Man machines could be performing much better than the $1 Ant Man machine. One theory is that the Ant Man $1 machines could be overpriced. Information gleaned from scanning the floor and section, and scrutinising slots could then be collated to answer a business question, for example “Are my slots priced appropriately?”.

The use of position data and time/date data in the interaction records enables a user to, for example, experiment with new layouts and compare the effectiveness of those new layouts with historical layouts. The invention could compare a current edited layout with the master layout, or with a historical layout. Change reports could then be produced from this data. This functionality would enable a user to conduct trend analysis based on both pricing changes and placement changes of individual gaming machines.

The foregoing describes the invention including preferred forms thereof Alterations and modifications as will be obvious to those skilled in the art are intended to be incorporated within the scope hereof, as defined by the accompanying claims.

1. A data analysis system comprising:
an interaction database maintained in computer memory, the interaction database comprising interaction data representing interactions between customers and merchants;
a spatial display component configured to display a graphical spatial representation of at least part of the commercial premises of a merchant;
a retrieval component configured to retrieve from the interaction database a plurality of data values representing interactions between customers and merchants;
a contour generator configured to generate and superimpose a representation of the data values on the spatial representation;
a user selection component configured to enable a user to select part of the spatial representation; and
a data display component configured to superimpose a representation of interactions between customers and merchants associated with the part of the spatial representation selected by the user.

2. A data analysis system as claimed in claim 1 wherein the merchant provides a plurality of products to customers, the spatial representation comprising representations of one or more of the products corresponding to the spatial position of the products within the commercial premises of the merchant.

3. A data analysis system as claimed in claim 2 wherein the user selection component is configured to enable a user to select a product in the spatial representation.

4. A data analysis system as claimed in claim 3 wherein the representation generated by the data display component is associated with the product selected by the user.

5. A data analysis system as claimed in claim 4 wherein the representation displays interactions between customers and merchants involving the product selected by the user.

6. A data analysis system as claimed in claim 1 wherein the contour generator is configured to generate and display a contoured representation of one or more of the data values centered on respective data points such that one or more of the data points is displayed as a local maximum.

7. A data analysis system as claimed in claim 1 wherein the contour generator is configured to generate and display data points corresponding to the data values on one or more contour lines around one or more of the data points, each contour line representing data values which are less than the data value of the data point around which the contour line is displayed.

8. A method of data analysis comprising the steps of:
maintaining in computer memory an interaction database, the interaction database comprising interaction data representing interactions between customers and merchants;
displaying a graphical spatial representation of at least part of the commercial premises of a merchant;
retrieving from the interaction database a plurality of data values representing interactions between customers and merchants;
generating and superimposing a representation of the data values on the spatial representation; and
superimposing a representation of interactions between customers and merchants associated with part of the spatial representation selected by a user.

9. A method of data analysis as claimed in claim 8 in which the merchant provides a plurality of products to customers, the method further comprising the step of displaying representations of one or more of the products corresponding to the spatial position of the products within the commercial premises of the merchant.

10. A method of data analysis as claimed in claim 9 further comprising the step of providing a user selection component to enable a user to select a product in the spatial representation.

11. A method of data analysis as claimed in claim 10 further comprising the step of generating and displaying a representation associated with the product selected by the user.

12. A method of data analysis as claimed in claim 11 further comprising the step of displaying a representation of interactions between customers and merchants involving the product selected by the user.

13. A method of data analysis as claimed in claim 8 further comprising the step of generating and displaying a contoured representation of one or more of the data values centered on respective data points, such that one or more of the data points is displayed as a local maximum.

14. A method of data analysis as claimed in claim 8 further comprising the step of generating and displaying data points corresponding to the data values and one or more contour lines around one or more of the data points, each contour line representing data values which are less than the data value of the data point around which the contour line is displayed.
